(19) United States
(12) Patent Application Publication
(10) Pub. No.: US 2013/0181968 A1
(43) Pub. Date: Jul. 18, 2013

(54) DRIVE CIRCUIT OF DISPLAY DEVICE, DISPLAY DEVICE, AND METHOD OF DRIVING DISPLAY DEVICE

(71) Applicants: Kentaroh Uemura, Osaka-shi (JP); Norio Ohmura, Osaka-shi (JP)

(72) Inventors: Kentaroh Uemura, Osaka-shi (JP); Norio Ohmura, Osaka-shi (JP)

(73) Assignee: SHARP KABUSHIKI KAISHA, Osaka-shi ,Osaka (JP)

(21) Appl. No.: 13/824,717

(22) PCT Filed: Sep. 14, 2011
(86) PCT No.: PCT/JP2011/070918

§ 371 Date: Mar. 18, 2013

(30) Foreign Application Priority Data
Sep. 21, 2010 (JP) 2010-211117

(51) Int. Cl. G09G 3/36

(52) U.S. Cl. CPC G09G 3/3696
USPC 345/212

(57) ABSTRACT

Three-dimensional images are displayed effectively even if a position of a display device is changed between a vertical position and a horizontal position. A drive circuit 50 of a display device according to the present technology includes a data line driver 3, a scanning line driver 8 and a display controller. The data line driver 3 applies a drive voltage to a plurality of data lines of the display device according to image data. The scanning line driver 8 scans at least every other line of a plurality of scanning lines GL of the display device with interlace scanning. If the display device displays three-dimensional images, the display controller controls the scanning line driver 8 to execute the interlace scanning and to supply image data to the data line driver 3.

### TECHNICAL FIELD

The present invention relates to a drive circuit of a display device, a display device, and a method of driving a display device. Especially, the present invention relates to a technology related to scanning of scanning signal lines in a display device including a three-dimensional display filter such as a parallax barrier or a lenticular lens.

### BACKGROUND ART

A display device including a display panel such as a liquid crystal panel is used for a portable terminal device such as a mobile phone and PDA or an electronic device such as a computer and a television. A parallax barrier or a lenticular lens is applied to such a display device to display three-dimensional images. Using a parallax barrier or a lenticular lens, each of a left eye and a right eye sees a different image and human beings sense a three-dimensional image due to binocular parallax. Patent Document 1 discloses one example of such a display device capable of displaying three-dimensional images.

Patent Document 1: Japanese Unexamined Patent Application Publication No. Hei 07-307960

### Problem to be Solved by the Invention

The display device disclosed in Patent Document 1 is a three-dimensional display device that outputs a right-eye image and a left-eye image alternately to adjacent source lines (data lines). With this configuration, the three-dimensional images are displayed without using high-speed multiplexer. However, the display device disclosed in Patent Document 1 is not supposed to be used with changing a position of the display device between a horizontal position and a vertical position, and therefore, three-dimensional images are not effectively displayed in such a display device if the position of the display device is changed between the horizontal position and the vertical position. Portable terminal devices are often used with changing their positions between the horizontal position and the vertical position. Therefore, it has been desired that three-dimensional images are effectively displayed even if the display device changes its position between the horizontal position and the vertical position.

### DISCLOSURE OF THE PRESENT INVENTION

The present invention was accomplished in view of the foregoing circumstances. An object of the present invention is to provide a technology in which three-dimensional images are effectively displayed even if a display device changes its position between a horizontal position and a vertical position.

### Means for Solving the Problem

To solve the above problem, a drive circuit of a display device according to the present technology drives the display device displaying a three-dimensional image and including a display panel and a three-dimensional display filter, and the display panel includes a plurality of data lines and a plurality of scanning lines that are perpendicular to the data lines, and the three-dimensional display filter includes a first filter having a filtering direction that is parallel to the scanning lines. The drive circuit includes a data line driver configured to apply a display drive voltage to the data lines according to image data, a scanning line driver configured to scan at least every other line of the scanning lines with interlace scanning, and a display controller configured to control the scanning line driver to execute the interlace scanning and supply the image data to the data line driver if the display device displays a three-dimensional image with using the first filter.

With such a configuration, if the display device displays three-dimensional images with using the first filter, at least every other line of the scanning lines is scanned with interlace scanning. Therefore, if the display device displays a three-dimensional image with using the first filter having the filtering direction that is parallel to the scanning lines, the left-eye image and the right-eye image are alternately displayed along the scanning lines. As a result, even if a position of the display device is changed between a vertical position and a horizontal position, three-dimensional images are effectively displayed. This configuration eliminates an image conversion circuit using a frame memory that has been required in displaying three-dimensional images if a position of the conventional display device is changed between a vertical position and a horizontal position.

In the drive circuit, the scanning line driver may include a plurality of output circuits configured to output scanning line drive signals to the scanning lines, and an output circuit controller configured to control output of the scanning line drive signals from the output circuits to execute the interlace scanning.

The scanning line driver may scan the scanning lines sequentially to execute sequential scanning.

The display controller may control the scanning line driver to execute the sequential scanning if the display device displays a two-dimensional image.

The three-dimensional display filter may further include a second filter having a filtering direction that is perpendicular to the scanning lines, and the display controller may control the scanning line driver to execute the sequential scanning if the display device displays a three-dimensional image with using the second filter.

The scanning line driver may include a plurality of first output circuits corresponding to odd-numbered scanning lines, a plurality of second output circuits corresponding to even-numbered scanning lines, and a determination signal input portion configured to receive a determination signal according to which one of the first output circuits and the second output circuits are selected.

The scanning line driver may execute the interlace scanning in one of a first mode and a second mode, and even-numbered scanning lines may be scanned after scanning odd-numbered scanning lines in the first mode, and the odd-numbered scanning lines may be scanned after scanning the even-numbered scanning lines in the second mode, and the scanning line driver may switch the interlace scanning mode between the first mode and the second mode in executing the interlace scanning.

The drive circuit may further include a dividing circuit configured to send the scanning line drive signal output from the scanning line driver to the scanning lines. The interlace scanning may be executed for every dividing circuit.

The dividing circuit may include three AND circuits. Each of the AND circuits may receive the scanning line drive signal and a scanning line activation signal that allows the scanning line drive signal to be sent to the scanning lines.

The scanning line driver may include the dividing circuit.

The three-dimensional display filter may be a parallax barrier configured with a switching liquid crystal panel, and the scanning line driver may execute scanning along the parallax barrier.

A display device includes any one of the above described drive circuits. The display panel may be a liquid crystal display panel using liquid crystals.

Such a display device is applied to various uses such as a mobile phone, a smart phone, a portable game machine, a notebook computer, a desktop of a personal computer or a television device as a liquid crystal display device, and especially appropriate for a display screen of various sizes.

In a method of driving a display device according to the present technology, the display device includes a display panel and a three-dimensional display filter and displays a three-dimensional image, and the display panel includes a plurality of data lines and a plurality of scanning lines. The method of driving the display device displaying a three-dimensional image includes applying a display drive voltage to the data lines according to image data, and scanning at least every other line of the scanning lines with interlace scanning.

In the interlace scanning, even-numbered scanning lines may be scanned after odd-numbered scanning lines are scanned or the odd-numbered scanning lines maybe scanned after the even-numbered scanning lines are scanned.

### Advantageous Effect of the Invention

According to the present invention, three-dimensional images are effectively displayed even if a display device changes its position between a horizontal position and a vertical position.

### BRIEF DESCRIPTION OF THE DRAWINGS

FIG. 1 is a cross-sectional view illustrating a general construction of a display device according to a first embodiment.

FIG. 2 is a block diagram typically illustrating an electric configuration of the display device of FIG. 1.

FIG. 3 is an explanation view illustrating a relation between a display panel and a parallax barrier.

FIG. 4 is an explanation view illustrating a scanning pattern of gate lines of a gate driver.

FIG. 5 is an explanation view illustrating a relation between an input image and an output image.

FIG. 6 is an explanation view illustrating another scanning pattern of the gate lines of the gate driver.

FIG. 7 is an explanation view illustrating a relation between the display panel and a parallax barrier in a horizontal position and a vertical position.

FIG. 8 is an explanation view illustrating input images corresponding to FIG. 7.

FIG. 9 is a block diagram generally illustrating a construction related to a gate driver according to a second embodiment.

FIG. 10 is a timing chart typically illustrating signals according to the second embodiment.

FIG. 11 is an explanation view illustrating a relation between a display panel and a parallax barrier according to the second embodiment.

### MODES FOR CARRYING OUT THE INVENTION

<First Embodiment>

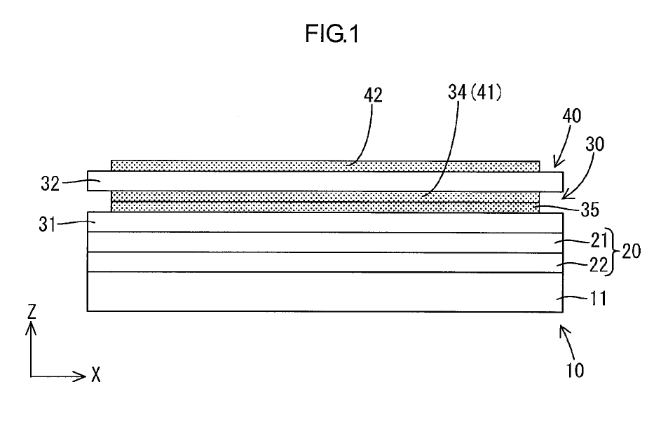

A first embodiment will be explained with reference to FIGS. 1 to 8. In the first embodiment, a liquid crystal display device 10 (display device) will be described as an example. The liquid crystal display device 10 is used as an information display element included in various electronic devices such as a portable information terminal, a mobile phone, a notebook computer, a portable game machine (not illustrated). An X-axis, a Y-axis and a Z-axis are described in a part of some drawings. A long-side of the liquid crystal display device 10 corresponds to the X-axis and a short-side thereof corresponds to the Y-axis. The up-down direction in FIG. 1 corresponds to the Z-axis (a front-rear direction, a direction vertical to a screen), and an upper side in FIG. 1 is a front-surface side and a lower side in FIG. 1 is a rear-surface side.

1. General Construction of Liquid Crystal Display Device

The liquid crystal display device 10 has a landscape quadrangular shape (rectangular shape) as a whole. As illustrated in FIG. 1, the liquid crystal display device 10 includes a backlight device 11, a liquid crystal display panel 20 (a display panel), a switching crystal liquid panel 30 (one of examples of a three-dimensional display filter), and a touch panel 40. The liquid crystal display panel 20, the switching liquid crystal panel 30 and the touch panel 40 are laminated on the backlight device 11 in this order. The touch panel 40 and the switching liquid crystal panel 30 are provided on a display surface side of the liquid crystal display panel 20. The liquid crystal display panel 20, the switching liquid crystal panel 30 and the touch panel 40 are electrically connected to a control circuit board (not illustrated) via a flexible board (not illustrated), for example.

The three-dimensional display filter is not limited to the parallax barrier using the switching liquid crystal panel 30, and a lenticular lens may be used as the three-dimensional display filter.

The backlight device 11 includes a chassis and light sources (for example, cold cathode tubes or LEDs (not illustrated)). The chassis is formed in substantially a box shape having an opening that is open to a front-surface side (a liquid crystal display panel 20 side) and houses the light sources therein. The backlight device 11 exits light toward the liquid crystal display panel 20.

The liquid crystal display panel 20 includes a pair of transparent (highly capable of light transmission) glass substrates 21, 22 and a liquid crystal layer (not illustrated). The liquid crystal layer is provided between the pair of transparent glass substrates 21, 22. The transparent glass substrates 21, 22 are bonded together with a sealing agent with ensuring a gap corresponding to a thickness of the liquid crystal layer.

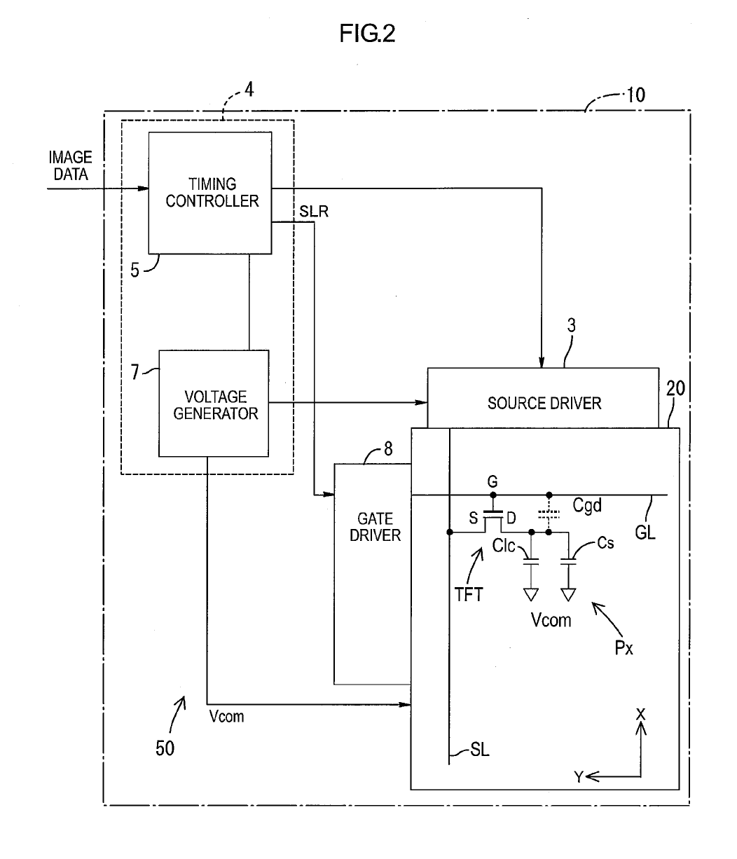

The transparent glass substrate 21 that is provided on a front-surface side (au upper side in FIG. 1) is a CF (color filter) board 21 and the transparent glass substrate 22 that is provided on a rear-surface side is a TFT board 22 (an element board). As illustrated in FIG. 2, a plurality of TFTs (thin film transistor) and pixel electrodes are arranged on an inner surface (a surface close to the liquid crystal layer, a surface facing the CF board 21) of the TFT board 22. The TFT is a switching component that drives liquid crystals for every pixel. One of the TFTs is illustrated in FIG. 2.

As illustrated in FIG. 2, gate lines GL (one of examples of a scanning line) and source lines SL (one of examples of data line) that are arranged in a grid pattern are provided to surround each of the TFTs and the pixel electrodes. The gate lines GL and the source lines SL are connected to gate electrodes G and source electrodes S of the TFTs, respectively, and the pixel electrodes are connected to drain electrodes D of the TFTs. Each of the pixel electrodes is a transparent electrode formed of ITO (Indium Tin Oxide) and the like.

Color filters having color sections such as R (red), G (green) and B (blue) color sections arranged corresponding to each pixel are provided on the CF board 21. Counter electrodes Vcom are provided on surfaces of the color filter and a light blocking layer so as to face the pixel electrodes on the TFT board 22.

The switching liquid crystal panel 30 and the touch panel 40 are integrally provided on a front surface side (an upper side in FIG. 1) of the liquid crystal display panel 20.

The switching liquid crystal panel 30 is arranged in adjacent to the liquid crystal display panel 20 and capable of switching a display mode between a two-dimensional display mode and a three-dimensional display mode. The switching liquid crystal panel 30 includes transparent (capable of light transmission) glass substrates 31, 32, a liquid crystal layer (not illustrated) that is provided between the substrates 31, 32, and a polarizing plate provided on an outer surface of the liquid crystal layer. The glass substrate 32 that is provided away from the liquid crystal display panel 20 configures apart of the touch panel 40 and is used commonly for the switching liquid crystal panel 30 and the touch panel 40.

The switching liquid crystal panel 30 includes switching liquid crystal panel electrodes 34, 35 that apply a voltage to the liquid crystal layer arranged between the substrates 31 and 32. Each of the electrodes 34, 35 is a transparent electrode and extends in a different direction.

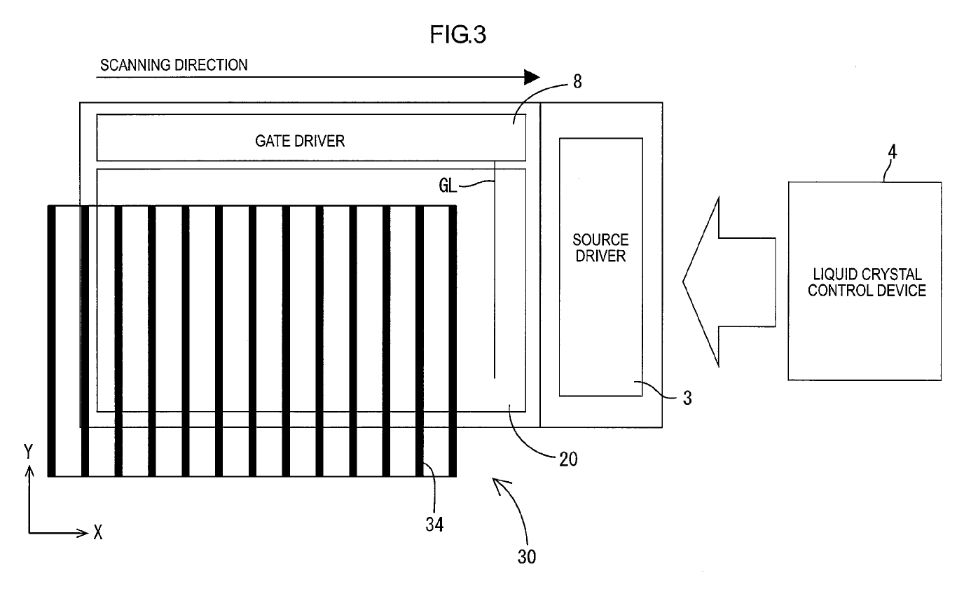

The first switching liquid crystal panel electrodes 34 that are provided close to the touch panel 40 and provided on the substrate 32 extend in the Y-axis direction (along one side of the liquid crystal display device 10, a direction along an extending direction of the gate line GL), as illustrated in FIG. 3.

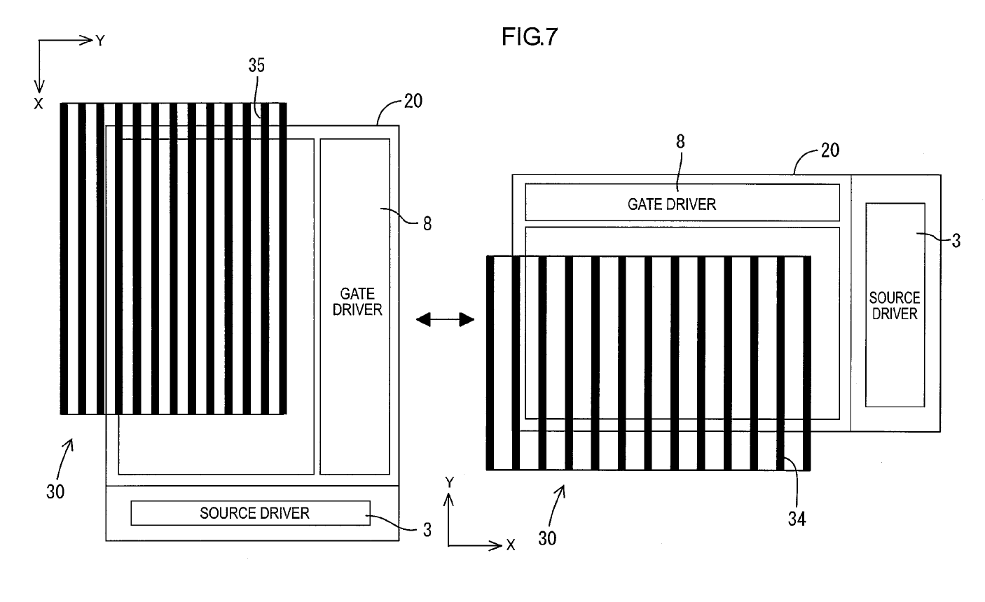

The second switching liquid crystal panel electrodes 35 that are provided on the glass substrate 31 and close to the liquid crystal display panel 20 extend in the X-axis direction (see FIG. 7).

If a predetermined drive voltage is applied to the first switching liquid crystal panel electrodes 34, light (that is exited from the backlight device 11 and transmitted through the liquid crystal display panel 20) is blocked at the portions of the switching liquid crystal panel 30 corresponding to the electrodes 34. Accordingly, in the liquid crystal display panel 20, one group of pixels can be seen by a right eye and another group of pixels can be seen by a left eye. The switching liquid crystal panel 30 functions as a parallax barrier if the liquid crystal display device 10 is in a horizontal position and this enables three-dimensional images to be displayed.

If a predetermined drive voltage is applied to the second switching liquid crystal panel transparent electrodes 35, the light is blocked at the portions of the switching liquid crystal panel 30 corresponding to the electrodes 35. Accordingly, in the liquid crystal display panel 20, one group of pixels can be seen by a right eye and another group of pixels can be seen by a left eye. The switching liquid crystal panel 30 functions as a parallax barrier if the liquid crystal display device 10 is in a vertical position and this enables three-dimensional images to be displayed.

In the present embodiment, the liquid crystal display device 10 includes two types of the switching liquid crystal panel electrodes 34, 35 that extend indifferent directions. Therefore, a parallax barrier is created in the long-side direction (the X direction) and the short-side direction (the Y direction) of the liquid crystal display device 10, and three-dimensional images are displayed in both cases in which the display device 10 is in the vertical position and in the horizontal position.

Pixels for a right eye and pixels for a left eye are displayed on the liquid crystal display panel 20. A viewer of the liquid crystal display device 10 can see the right eye pixels (R) with his/her right eye and see the left eye pixels (L) with his/her left eye via the light transmission portions formed on the switching liquid crystal panel 30. A predetermined voltage (including grounded) is applied to the first switching liquid crystal panel electrodes 34 and the second switching liquid crystal panel electrodes 35, and accordingly the light transmission portions are formed on an almost entire area of the switching liquid crystal display panel 30. This enables two-dimensional images to be displayed. In the present embodiment, a normally black mode in which light is not transmitted through the switching liquid crystal with no application of a voltage is used as the mode of the switching liquid crystals. However, a normally white mode in which light is transmitted through the switching liquid crystal with no application of a voltage may be used.

The touch panel 40 includes touch panel electrodes 41, 42 each of which is a transparent electrode and provided on a front surface and a rear surface of the common board 32. Specifically, the electrode 34 provided on the rear surface of the board 32 and extending in the Y-axis direction is used as the first touch panel electrode 41. The second touch panel electrode 42 is provided on the front surface of the board 32 and extends in the X-axis direction (a direction perpendicular to the first touch panel electrode 41).

2. Configuration of Drive Circuit

As illustrated in FIG. 2, the liquid crystal display device 10 includes a drive circuit 50 (one of examples of a drive circuit of a display device). The drive circuit 50 includes a source driver 3 (one of examples of a data line driver), a liquid crystal control device 4 (one of examples of a display controller), and a gate driver 8 (one of examples of a scanning line driver). In FIG. 2, the source driver 3 and the gate driver 8 are connected to each other with a TAB method (a tape automated bonding method). However, this is not limited thereto and they may be connected to each other with a COG method (a chip on glass method). Namely, the source driver 3 and the gate driver 8 may be provided on the liquid crystal display panel 20 side.

The source driver 3 applies a gradation voltage (corresponding to a display drive voltage) corresponding to image data to the source line SL according to control of the liquid crystal control device 4.

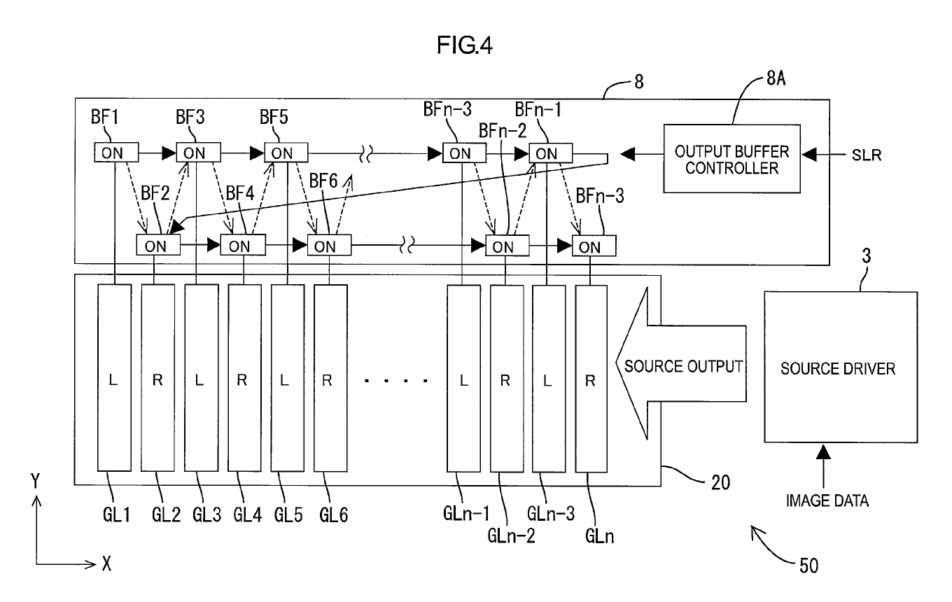

The gate driver 8 has two types of scanning including normal non-interlace scanning and interlace scanning. The gate driver 8 sequentially scans the gate lines GL in the non-interlace scanning and scans at least every other one of the gate lines GL in the interlace scanning according to the control of the liquid crystal control device 4. The gate driver 8 includes a predetermined number of output buffers BF and an output buffer controller 8A (see FIG. 4). Each of the output buffers BF outputs a gate line drive signal Sgd (an output signal) to the gate line GL with time-sharing. The output buffer controller 8A controls each of the output buffers BF. The output buffer controller 8A is connected to each of the output buffers BF. The output buffer controller 8A controls a driving order in which each of the output buffers BF is driven and controls supply of the gate line drive signal Sgd from each of the output buffers BF to the gate line GL according to the control of the liquid crystal control device 4.

The number of the gate drivers 8 and the output buffers BF is determined according to a size (the number of pixels) of the liquid crystal panel 20. The functions of the output buffer controller 8A may be included in the liquid crystal control device 4.

The liquid crystal control device 4 includes a timing controller 5 and a voltage generator 7. If the liquid crystal display device 10 is in the three-dimensional display mode, the liquid crystal control device 4 controls the gate driver 8 to execute the interlace scanning. Specifically, the liquid crystal control device 4 controls the output buffer controller 8A of the gate driver 8 and sends signals relating image data to the source driver 3.

The voltage generator 7 receives a predetermined power source voltage from a power source (not illustrated) and generates various voltages based on the power source voltage. Various voltages include a common electrode voltage Vcom, and a reference voltage based on which a gradation voltage is generated. The common electrode voltage Vcom is supplied to a common electrode of the liquid crystal panel 2 and the reference voltage is supplied to the source driver 3.

The timing controller 5 generates various signals that are sent to the source driver 3 and the gate driver 8 based on image signals (image data). The timing controller 5 may be configured with an ASIC (application specific integrated circuit). The whole drive circuit 50 may be configured with an ASIC.

3. Three-dimensional Display Mode

(First Example)

A first example of the first embodiment in the three-dimensional display mode will be explained with reference to FIGS. 3 to 5.

The liquid crystal display device 10 is used in the horizontal position mode (a landscape mode) in which the display device 10 is rotated by 90 degrees from the vertical position mode (in a portrait mode). The timing controller 5 of the liquid crystal display device 10 receives image data from a host device with a side-by-side format.

In such a case, an extending direction of the first switching liquid crystal panel electrodes 34 of the switching liquid crystal panel 30 (a direction of a filter) is parallel to (in a same direction as) an extending direction of the gate lines GL (the Y-axis direction).

The output buffers BFn (n=even number) of the gate driver 8 are driven in an order described below. As illustrated by solid arrows in FIG. 4, the output buffers BF1 to BFn-1 (correspond to a plurality of first output circuits) that are connected to the odd-numbered gate lines GL1 to GLn-1 are first driven, and thereafter, the output buffers BF2 to BFn (correspond to a plurality of second output circuits) that are connected to the even-numbered gate lines are driven (a first mode). Accordingly, every other line of the gate lines GLn is scanned with interlace scanning.

The source driver 3 receives image data and outputs the image data to every other line of the gate lines GL. If the image data that the source driver 3 receives is configured with left-eye images L and right-eye images R (the side-by-side format), the left-eye image L and the right-eye image R are output for display alternately to each of the gate lines GL as illustrated in FIG. 4. Accordingly, three-dimensional images are displayed by the operation of the switching liquid crystal panel (a parallax barrier) 30.

If images are displayed in a two-dimensional display mode (in a normal display mode), the output buffers BFn of the gate driver 8 are driven in an order described below. As illustrated by dotted arrows in FIG. 4, the output buffers BFn are controlled such that the odd-numbered gate lines GL and the even-numbered gate lines GL are driven alternately. Namely, the gate lines GL are driven from an odd-numbered gate line GL1, an even-numbered gate line GL2, an odd-numbered gate line GL3 . . . an even-numbered gate line BFn in this order so as to be scanned sequentially. In such a case, the source driver 3 receives the image data and outputs the image data sequentially to the liquid crystal panel 20. The filtering operation of the switching liquid crystal panel 30 is deactivated. Accordingly, images are displayed two-dimensionally (in the normal display mode).

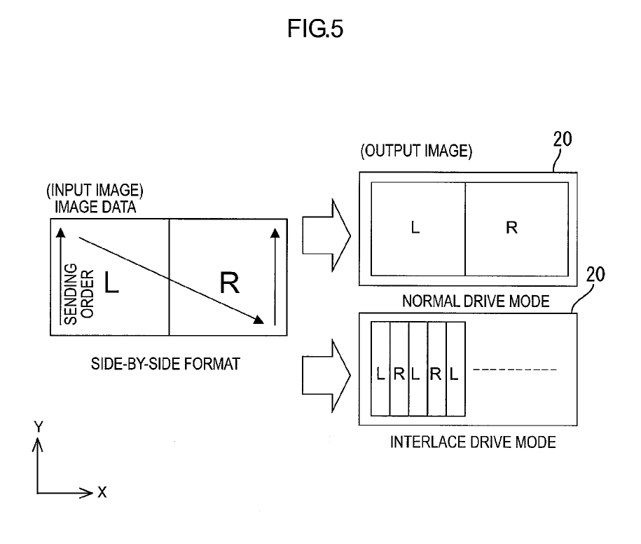

FIG. 5 illustrates a relation between the images input to the liquid crystal control device 4 and the images output to the liquid crystal panel 20 when the output buffers BFn are in the normal drive mode (the two-dimensional display mode) and in the interlace drive mode (the three-dimensional display mode).

In the first example, the order of driving the output buffers BFn of the gate driver 8 is changed and the order of outputting the image data from the source driver 3 is changed. Accordingly, if the liquid crystal display device 10 is used in the horizontal position mode, the two-dimensional display mode and the three-dimensional display mode are easily switched threrebetween.

If three dimensional images are displayed in the liquid crystal display device 10 in the landscape mode in which the display device is rotated at 90 degrees from the position thereof in the portrait mode, the liquid crystal panel 20 is driven in the scanning direction with interlace driving. Accordingly, the input images having the side-by-side format is output to the liquid crystal panel 20 without converting the images. This configuration eliminates an image conversion circuit using a frame memory that has been required for image conversion in displaying three-dimensional images in the landscape mode in which the conventional display device is rotated at 90 degrees from the position thereof in the portrait mode.

If the three-dimensional display filter is fixed and the parallax barrier that is created by the switching liquid crystal panel 30 is fixed, the following problem may be caused. If a viewer of the liquid crystal display device 10 changes his/her position from the front to a right side or a left side with respect to the liquid crystal display device 10, the right-eye images R and the left-eye images L may be reversed and the right-eye images R may be seen by the left eye and the left-eye images L may be seen by the right eye (reverse viewing).

The right-eye images R and the light-eye images L are switched by changing the order of driving the output buffers BFn of the gate driver 8 so as to prevent the reverse viewing and achieve normal viewing easily.

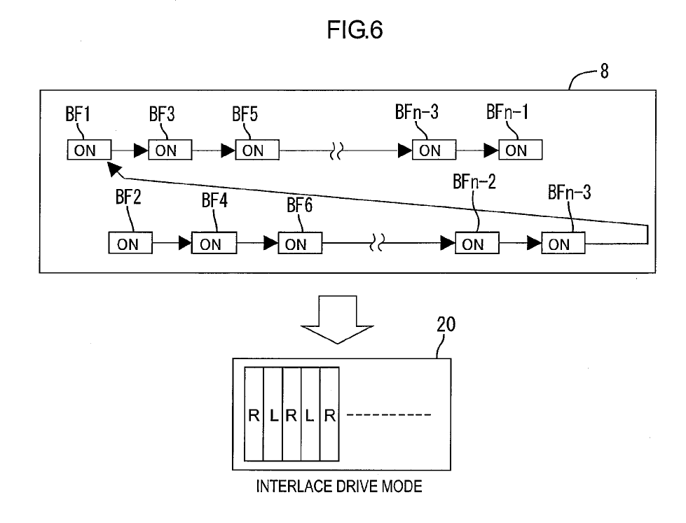

Namely, the order of driving the output buffers BFn of the gate driver 8 is as follows. As illustrated by solid arrows in FIG. 6, the output buffers BF2 to BFn connected to the even-numbered gate lines GL2 to GLn are driven first, and thereafter, the output buffers BF1 to BFn-1 connected to the odd-numbered gate lines GL1 to GLn-1 are driven (a second mode). Accordingly, the gate lines GLn corresponding to the right-eye images Rare scanned with interlace scanning. Namely, every other line of the gate lines GLn is scanned and the right-eye images are displayed on the liquid crystal panel 20 first. With this configuration, the left-eye images and the right eye-images are not necessary to be switched by the host device.

(Second Example)

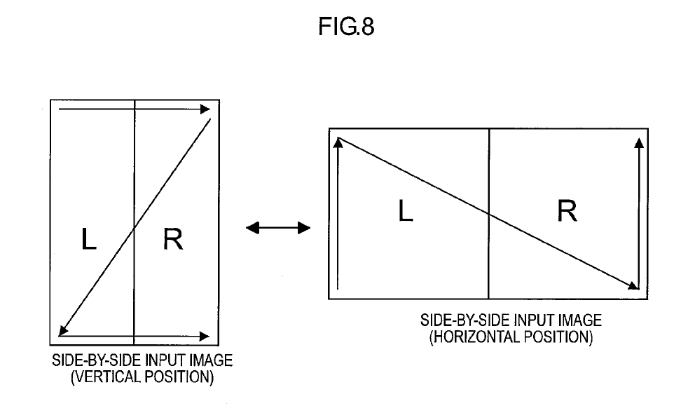

Next, a second example will be explained with reference to FIGS. 7 and 8. In the second example, the three-dimensional display in the liquid crystal display device 10 that is used in the vertical position mode will be explained.

As illustrated in FIG. 7, a predetermined drive voltage is applied to the second switching liquid crystal panel transparent electrodes 35 of the switching liquid crystal panel 30 to create a vertical parallax barrier.

The source driver 3 arranges the side-by-side input image for vertical display illustrated in FIG. 8 in following two methods. In one method, each of pixels included in the side-by-side input image for vertical display is rearranged such that left-eye pixels and right-eye pixels of the input image are alternately arranged in the driver. In another method, the side-by-side input image for vertical display is arranged sequentially.

If three-dimensional images are displayed in the vertical position mode of the liquid crystal display device 10, similar to the gate driver 8 in the horizontal position mode, the source driver 3 switches the left image data and the right image data according to the output buffers of the source driver 3, and the image data that is specifically a drive voltage (a gradation voltage) corresponding to the image data is supplied to each source line SL. The gate driver 8 scans the gate lines GL in a normal scanning mode (the non-interlace scanning).

According to the liquid crystal display device 10 of the present embodiment, three-dimensional images are displayed effectively in both of the horizontal position mode and the vertical position mode.

(Third Example)

In a third example, three-dimensional display of image data that is sent with alternate frame sequencing will be explained. In the alternate frame sequencing, left-eye images and right-eye images are alternately sent for every frame.

The output buffer controller (one of examples of a determination signal input portion) 8A of the gate driver 8 receives a left-right determination signal (one of examples of a determination signal) SLR, and selects one of an odd-numbered output buffer BF and an even-numbered output buffer BF according to the left-right determination signal SLR. The left-right determination signal SLR may be sent from a host device connected to the liquid crystal control device 4 or may be sent from the source driver 3 or may be sent from the timing controller 5.

If the image data sent from the host device has an alternate frame sequencing format, the left-right determination signal SLR is sent to the output buffer controller 7A of the gate driver 8 and three-dimensional images are displayed.

For example, if the left-right determination signal SLR designates a left-eye frame, the output buffer controller 7A selects the odd-numbered output buffers BF1 to BFn-1. If the left-right determination signal SLR designates a right-eye frame, the output buffer controller 7A selects the even-numbered output buffers BF2 to BFn. Thus, if the image data has an alternate frame sequencing format, the image data is displayed on the liquid crystal panel 20 as illustrated in FIG. 4. If the liquid crystal display device 10 is used in the horizontal position mode and the image data has an alternate frame sequencing format, three-dimensional images are effectively displayed.

If the display device 10 is in the vertical position mode, the output buffers of the source drive 3 are selected based on the left-right determination signal SLR, and accordingly, even if the image data has an alternate frame sequencing format, three-dimensional images are effectively displayed.

<Second Embodiment>

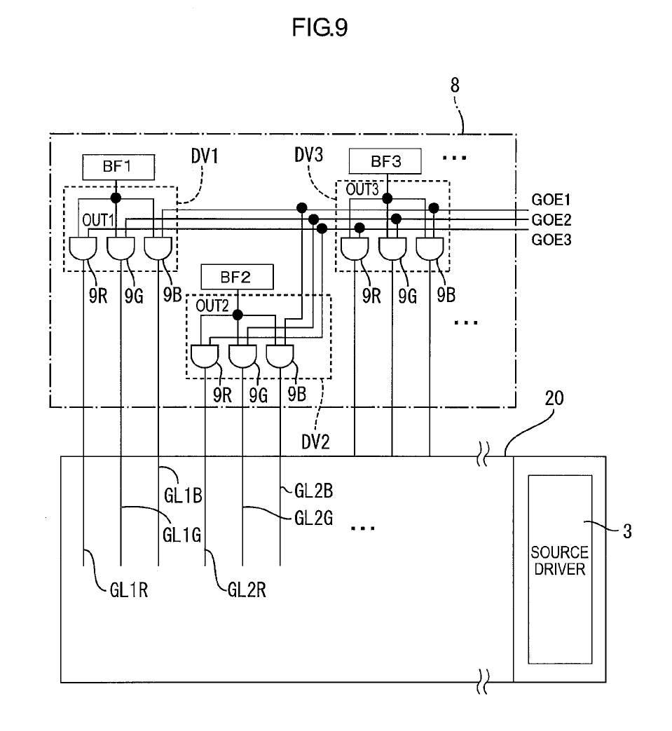

A second embodiment will be explained with reference to FIGS. 9 to 11. In the first embodiment, every other line of the gate lines GL is scanned with interlace scanning. In a third embodiment, every plurality lines of the gate lines GL are scanned with interlace scanning.

Specifically, as illustrated in FIG. 9, the gate driver 8 further includes dividing circuits DVn that send an output gate line drive signal Sgdn to a plurality of gate lines. The interlace scanning is executed for every dividing circuit DVn. In the present embodiment, for example, after scanning of the gate lines connected to the odd-numbered dividing circuits DV1, DV3 . . . DVn-1 (n is an even number), scanning of the even-numbered dividing circuits DV2, DV4 . . . DVn is started.

Each dividing circuit DVn includes three AND circuits 9R, 9G, 9B. Each of the AND circuits 9R, 9G, 9B receives a buffer output signal OUTn and activation signals GOE1 to GOE3, and generates each gate line drive signal Sgdn based on an AND operation of the buffer output signal OUTn and the activation signal GOEn.

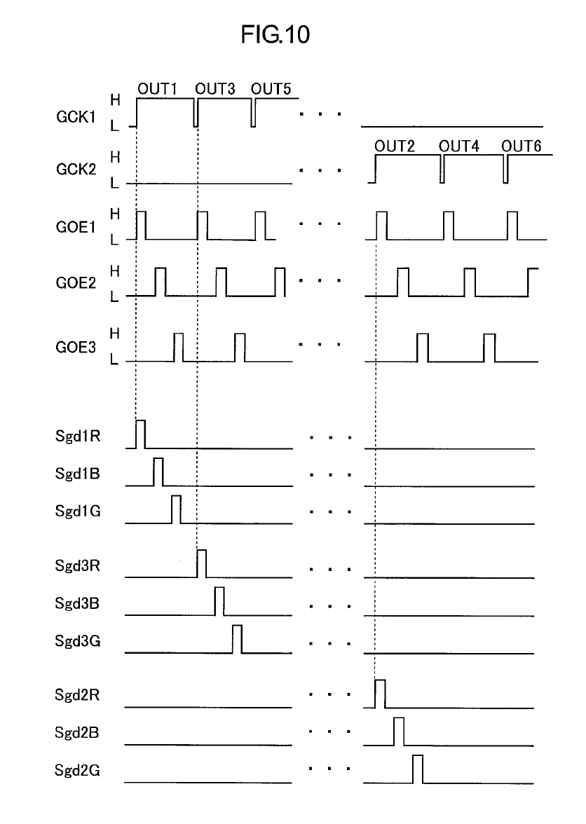

FIG. 10 is a timing chart illustrating a relation between the buffer output signals OUTn, the activation signals GOE1 to GOE3, and each gate line drive signal Sgdn. For example, if the buffer output signal OUT1 has a high level and the activation signal GOE1 is input to the AND circuit 9R of the dividing circuit DV1, a gate line drive signal Sgd1R is generated.

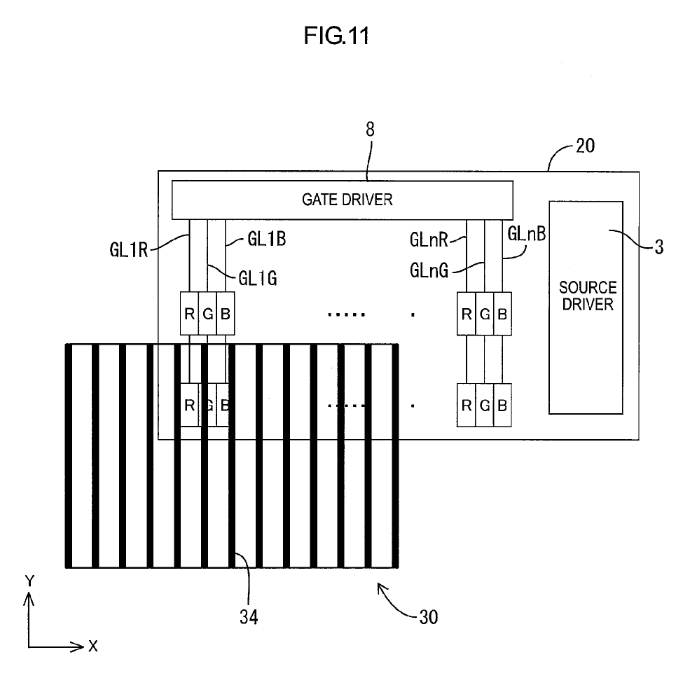

In the second embodiment, the gate lines GLn are scanned with interlace scanning by every three gate lines GLn that are configured as one set. Therefore, as illustrated in FIG. 11, a color liquid crystal display device 10 includes three gate lines GLn of R (red), G (green), and B (blue) that are connected to each pixel Px, and if such a color liquid crystal display device 10 is in the horizontal position, three-dimensional images are displayed effectively. Namely, even if the display panel including a plurality of gate lines GLn that are connected to each pixel Px such as a triple gate scan panel is rotated by 90 degrees and used in the horizontal position, three-dimensional images are displayed effectively.

The gate drive 8 includes the dividing circuits DVn therein in the present embodiment. However, the dividing circuits DVn may be provided outside of the gate driver 8. Every three gate lines GLn are not necessarily configured as one set to be scanned with interlace scanning. For example, every two gate lines GLn or every four gate lines GLn may be configured as one set such that the gate lines GLn are scanned with interlace scanning. The dividing circuit DV is not necessarily configured with three AND circuits.

<Other Embodiments>

The present invention is not limited to the above embodiments described in the above description and the drawings. The following embodiments are also included in the technical scope of the present invention, for example.

(1) In the above embodiments, the liquid crystal panel is used as the display panel. However, other kinds of display panels such as an EL panel may be included in the display device.

(2) In the above embodiments, each of the liquid crystal control device 4, the gate driver 8, and the source driver 3 is configured separately from each other. However, this is not limited thereto. For example, the liquid crystal control device 4 and the gate driver 8 may be configured with a single integrated circuit.

### EXPLANATION OF SYMBOLS

3: Source driver (Data line driver)

4: Liquid crystal control device (Display controller)

8: Gate driver (Scanning line driver)

8A: Output buffer controller

9: AND circuit

10: Liquid crystal display device (Display device)

20: Liquid crystal display panel (Display panel)

34: First switching liquid crystal panel electrode

35: Second switching liquid crystal panel electrode

BF: Output buffer (Output circuit)

DV: Dividing circuit

1. A drive circuit that drives a display device displaying a three-dimensional image and including a display panel and a three-dimensional display filter, the display panel including a plurality of data lines and a plurality of scanning lines that are perpendicular to the data lines, the three-dimensional display filter including a first filter having a filtering direction that is parallel to the scanning lines, the drive circuit comprising:
a data line driver configured to apply a display drive voltage to the data lines according to image data;
a scanning line driver configured to scan at least every other line of the scanning lines with interlace scanning; and
a display controller configured to control the scanning line driver to execute the interlace scanning and supply the image data to the data line driver if the display device displays a three-dimensional image with using the first filter.

2. The drive circuit according to claim 1, wherein the scanning line driver includes:
a plurality of output circuits configured to output scanning line drive signals to the scanning lines; and
an output circuit controller configured to control output of the scanning line drive signals from the output circuits to execute the interlace scanning.

3. The drive circuit according to claim 1, wherein the scanning line driver scans the scanning lines sequentially to execute sequential scanning.

4. The drive circuit according to claim 3, wherein the display controller controls the scanning line driver to execute the sequential scanning if the display device displays a two-dimensional image.

5. The drive circuit according to claim 1, wherein
the three-dimensional display filter further includes a second filter having a filtering direction that is perpendicular to the scanning lines, and
the display controller controls the scanning line driver to execute the sequential scanning if the display device displays a three-dimensional image with using the second filter.

6. The drive circuit according to claim 1, wherein the scanning line driver includes:
a plurality of first output circuits corresponding to odd-numbered scanning lines;
a plurality of second output circuits corresponding to even-numbered scanning lines; and
a determination signal input portion configured to receive a determination signal according to which one of the first output circuits and the second output circuits are selected.

7. The drive circuit according to claim 1, wherein
the scanning line driver executes the interlace scanning in one of a first mode and a second mode, and even-numbered scanning lines are scanned after scanning odd-numbered scanning lines in the first mode, and the odd-numbered scanning lines are scanned after scanning the even-numbered scanning lines in the second mode, and
the scanning line driver switches the interlace scanning mode between the first mode and the second mode in executing the interlace scanning.

8. The drive circuit according to claim 1, further comprising a dividing circuit configured to send the scanning line drive signal output from the scanning line driver to the scanning lines, wherein
the interlace scanning is executed for every dividing circuit.

9. The drive circuit according to claim 8, wherein
the dividing circuit includes three AND circuits, and
each of the AND circuits receives the scanning line drive signal and a scanning line activation signal that allows the scanning line drive signal to be sent to the scanning lines.

10. The drive circuit according to claim 8, wherein the scanning line driver includes the dividing circuit.

11. The drive circuit according to claim 1, wherein
the three-dimensional display filter is a parallax barrier configured with a switching liquid crystal panel, and
the scanning line driver executes scanning along the parallax barrier.

12. A display device comprising the drive circuit according to claim 1.

13. The display device according to claim 12, wherein the display panel is a liquid crystal display panel using liquid crystals.

14. A method of driving a display device that includes a display panel and a three-dimensional display filter and displays a three-dimensional image, the display panel including a plurality of data lines and a plurality of scanning lines, the method of driving the display device displaying a three-dimensional image comprising:
applying a display drive voltage to the data lines according to image data; and
scanning at least every other line of the scanning lines with interlace scanning.

15. The method according to claim 14, wherein in the interlace scanning, even-numbered scanning lines are scanned after odd-numbered scanning lines are scanned or the odd-numbered scanning lines are scanned after the even-numbered scanning lines are scanned.
